(19) United States
(12) Patent Application Publication
(10) Pub. No.: US 2016/0150425 A1
(43) Pub. Date: May 26, 2016

(54) SYSTEM AND METHOD OF PROVIDING A SYNTHETIC TRANSACTION PLATFORM FOR ANALYZING COMMUNICATION BETWEEN A MOBILE DEVICE AND A WIRELESS NETWORK

(71) Applicant: Bahadir Kuru, Istanbul (TR)

(72) Inventor: Bahadir Kuru, Istanbul (TR)

(21) Appl. No.: 14/550,937

(22) Filed: Nov. 22, 2014

(51) Int. Cl. H04W 24/06; H04W 4/12; H04W 76/02; H04L 29/08

(52) U.S. Cl. CPC H04W 24/06; H04L 67/20; H04W 4/12; H04W 76/021

(57) ABSTRACT

A method is disclosed for providing a platform for analyzing communication between a mobile device and a wireless network. The method comprises checking on the central management system for one or more codes associated with one or more tests to be executed by an agent on the mobile device and sending, by the central management system, a message to the mobile device over the wireless network, wherein the message includes the one or more codes associated with the one or more tests (synthetic transactions) to be executed by the agent.

### FIELD OF THE INVENTION

The present invention relates to a system and method of providing a platform for analyzing communication between a mobile device and a wireless network.

### BACKGROUND OF THE INVENTION

The wireless industry continues to analyze network performance in the mobile device, i.e., communication between mobile devices and wireless networks, in an attempt to improve network quality and user experience. Current technology to perform this task is unfortunately inadequate. In one instance, network performance is measured by a simple speed test wherein a test file is uploaded and downloaded from/to a mobile device for measuring throughput. Unfortunately, this type of test does not accurately reflect network performance. Platforms that allegedly perform mobile data analytics also do not provide any real data metrics for wireless network performance.

Therefore, it would be advantageous to provide a system and method that overcomes the disadvantages with systems described above.

### SUMMARY OF THE INVENTION

A system and method is disclosed of providing a platform for analyzing communication between a mobile device and a wireless network.

In accordance with an embodiment of the present disclosure, a method is disclosed for providing a platform for analyzing communication between a mobile device and a wireless network. The method comprises checking on a central management system for one or more codes associated with one or more tests to be executed by an agent on the mobile device and sending, by the central management system, a message to the mobile device over the wireless network, wherein the message includes the one or more codes associated with the one or more tests to be executed by the agent.

In accordance with another embodiment of the present disclosure, a system is disclosed of providing a platform for analyzing communication between a mobile device and a wireless network. The system comprise a data storage to store: a first database, wherein one or more mobile device IDs are stored in the first database, an second database, wherein one or more codes associated with one or more tests to be executed by an agent on a mobile device, and a one or more servers configured to execute steps of a method, the steps comprising receiving a message from the mobile device, wherein the message includes a mobile device ID associated with the mobile device; sending, by the one or more servers, a message to the mobile device over the wireless network if the mobile device ID matches a mobile device ID stored in mobile device ID database, wherein the message includes one or more codes associated with one or more tests to be executed by an agent on the mobile device.

In accordance with yet another embodiment of the present disclosure, a system is disclosed of providing a platform for analyzing communication between a mobile device and a wireless network, the system including one or more servers comprising at least one memory for storing computer-executable instructions, and at least one processor in communication with the at least one memory, wherein the processor is configured to execute the computer-executable instructions to register a mobile device to enable communication with the one more servers, and send a message to the mobile device over the wireless network, wherein the message includes one or more codes associated with tests to be executed by the mobile device.

In accordance with yet another embodiment of the present disclosure, a computer readable medium is disclosed for storing at least one computer program for providing a platform for analyzing communication between a mobile device and a wireless network, the at least one computer program comprising instructions, which when executed by one or more servers, cause the mobile device or personal computer to check for one or more codes associated with one or more tests to be executed by an agent on the mobile device, and send a message to the mobile device over the wireless network, wherein the message includes the one or more codes associated with the one or more tests to be executed by the agent on the mobile device.

In accordance with another embodiment of the disclosure, a method is disclosed of providing a platform for analyzing communication between a mobile device and a wireless network. The method comprises executing, by an agent on the mobile device, a synthetic transaction for measuring capability of the wireless network.

### BRIEF DESCRIPTION OF THE DRAWINGS

FIG. 1 depicts a block diagram an example system of providing a platform for analyzing communication between a mobile device and a network.

FIG. 2 depicts an example central management system as shown in FIG. 1.

FIG. 3 depicts an example mobile device as shown in FIG. 1.

FIG. 4 depicts a flowchart of an example process for registering a mobile device with the central management system in FIG. 1.

FIG. 5 depicts a flowchart of an example process for establishing communicating between a mobile device and central management system.

FIG. 6 depicts a block diagram of the components within a mobile device shown in FIG. 1.

FIG. 7 depicts a general-purpose computer to support the embodiments of the systems and methods including computer components disclosed in this application.

### DETAILED DESCRIPTION OF THE INVENTION

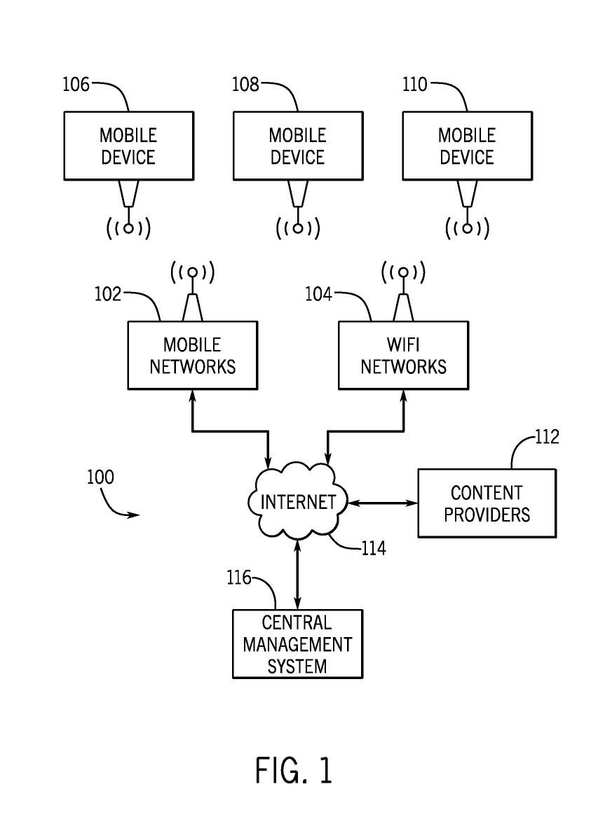

FIG. 1 depicts a block diagram of an example system 100 incorporating a platform for analyzing the communication between a mobile device and a wireless network. The analysis is used to determine or assess network performance for the entire network, a part of a network or a part of a network that serves to add a particular user mobile device or a group of user mobile devices. To effect such analysis, system 100 enables an operator to induce, demand or schedule testing activity, including information gathering and/or information exchange to/from a mobile device. This testing (i.e., tests) activity is also referred to as a synthetic transaction. This is described in more detail below.

System 100 comprises wireless networks such as mobile networks 102 that deliver wireless communication services as known to those skilled in the art. Mobile networks 102 are owned and operated by Verizon, Sprint, AT&T and T-Mobile for example. (Mobile network is also referred to as a cellular network or carrier network as known to those skilled in the art and these terms are used interchangeably in this disclosure.) Mobile networks 102 may include any number of networks as known to those skilled in the art. The wireless networks also comprise one or more WIFI networks 104 that also provide wireless communication as known to those skilled in the art.

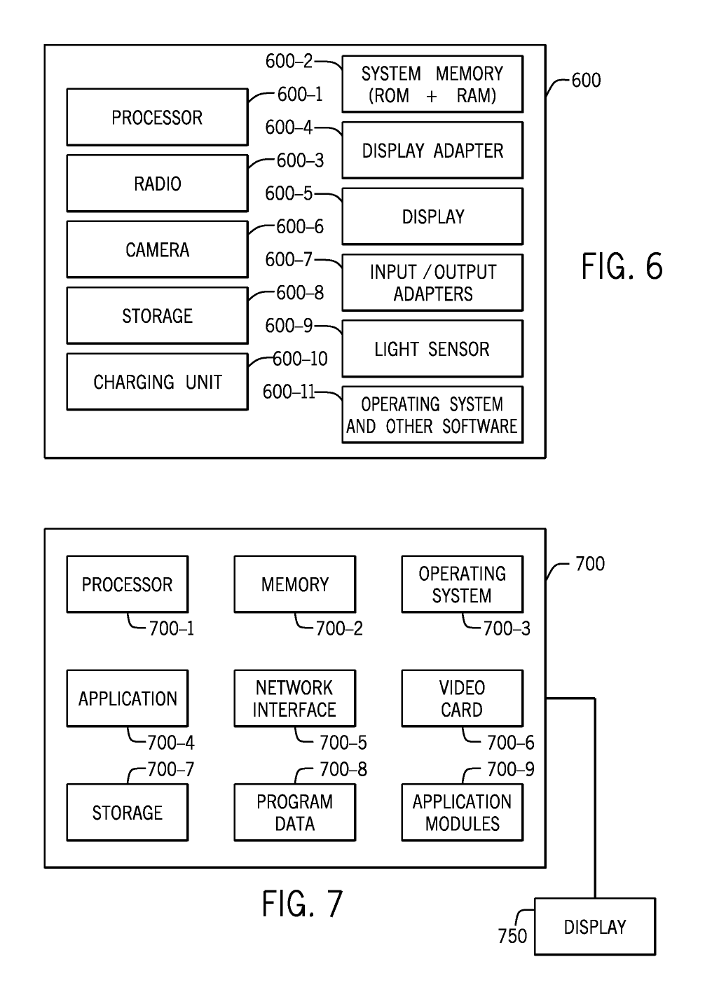

System 100 also comprises mobile devices 106, 108, 110 and one or more content providers 112. Mobile devices 106, 108, 110 are adapted to wirelessly access content from content providers 112 over a network such as Internet 114 via mobile networks 102 or WIFI networks 104 as known by those skilled in the art. Mobile devices 106, 108, 110 include cell phones, smartphones, PDAs, tablets, watches, laptops and other devices that allow a user to communicate wirelessly to mobile networks 102, WIFI networks 104 or other wireless networks. A typical mobile device has a processor, storage (ROM and RAM memory), interface and antenna to enable the device to communication with a wireless network (mobile or WIFI networks), and other components as known to those skilled in the art. A representative mobile device is shown in FIG. 6 wherein internal components are depicted.

A user of a mobile device typically has many applications stored on such device to access content over Internet 114. For example, mobile applications may include Facebook, Twitter and LinkedIn (social networking), Mercury News, Washington Post, CNN (several news aggregators), YouTube (video), Firefox, Safari (web browsers) and many, many more applications. Each of these applications may also enable a user to access video and other content that requires large volumes of data transmission. Three mobile devices are shown, but those skilled in the art know that any number of mobile devices may be employed. In the typically mobile environment, thousands of mobile devices are wirelessly coupled to mobile and/or WIFI networks at any given time.

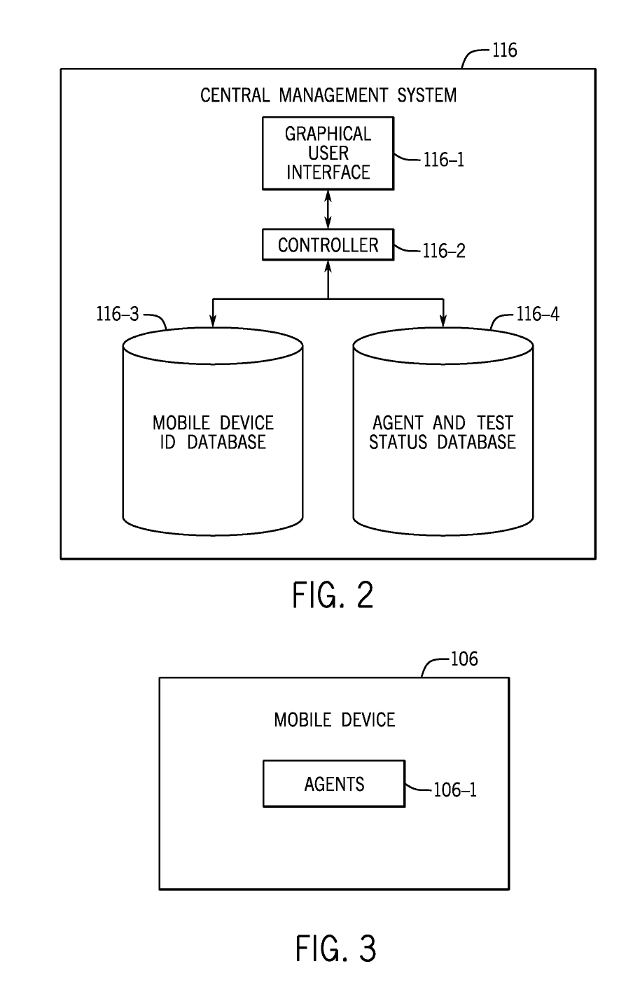

System 100 further comprises central management system (CMS) 116 (i.e., remotely within the cloud). In brief, CMS 116 provides an interface to an operator (user) to view test orders, i.e., synthetic transaction orders for selected mobile devices as described in more detail below. CMS 116 and content providers 112 include one or more servers as known to those skilled in the art. At least one server is adapted to communicate with Internet 60 as described below. A representative server is shown in FIG. 7 wherein internal components are depicted. FIG. 2 depicts an example CMS 116 as shown in FIG. 1 wherein certain internal applications and databases are shown. (Those skilled in the art, however, know that the depiction is not limited to those applications and databases. Other applications and databases may be included in CMS 116 or some or all of the applications and databases may be replaced with different applications etc. to achieve the same desired results.)

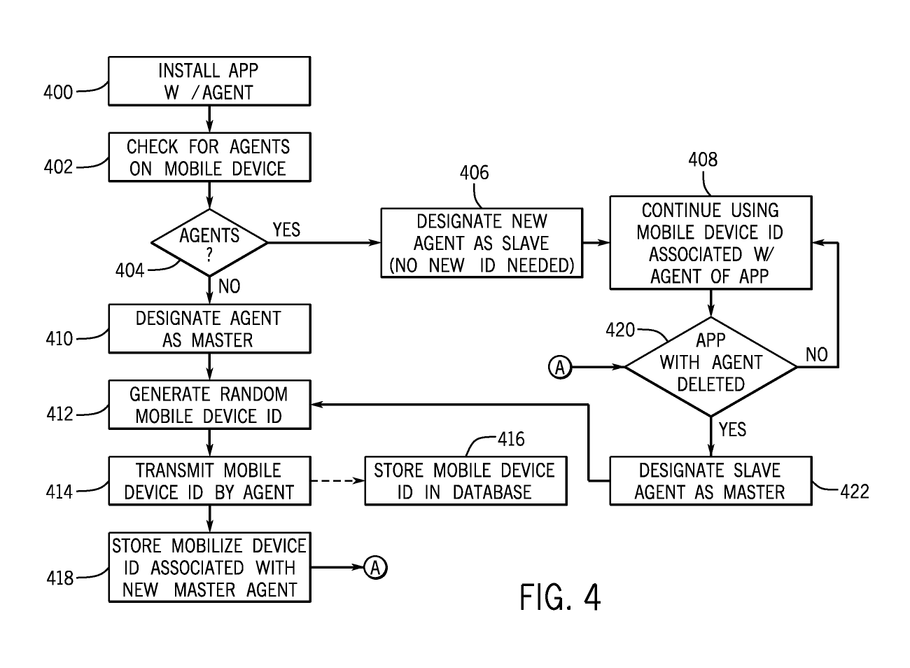

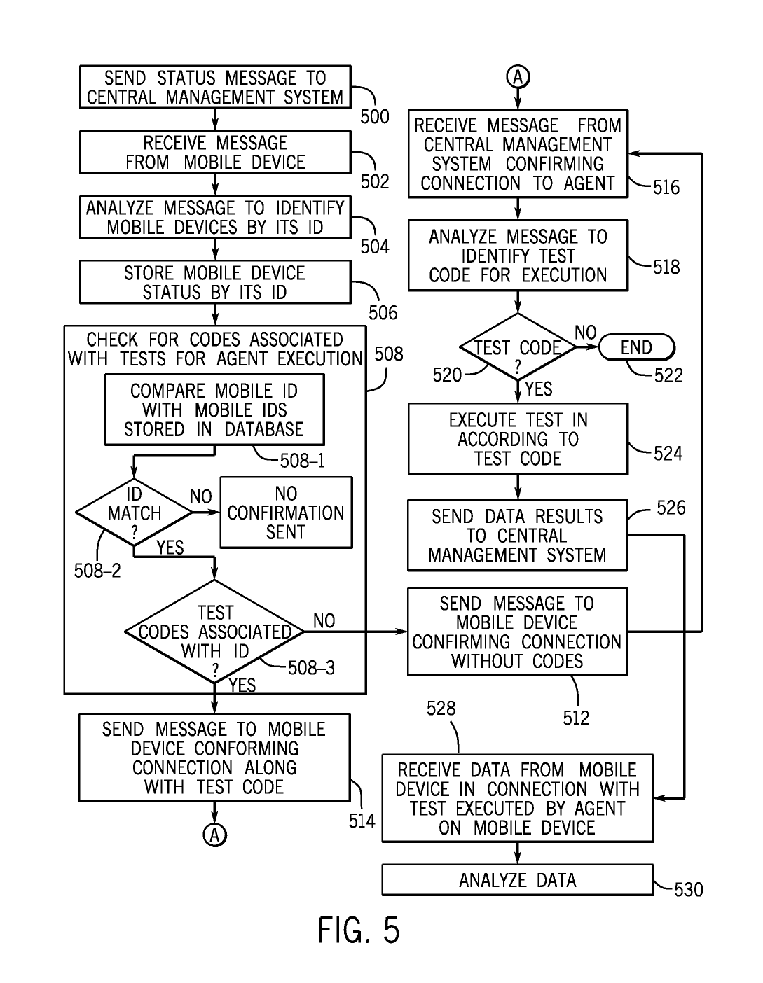

In particular, CMS 116 comprises graphical user interface (GUI) 116-1, controller 116-2 (software), mobile device identification (ID) database 116-2b and agent and test status database 116-4. GUI 116-1 is an interface between an operator (user) and controller 116-2b as known to those skilled in the art. Controller 116-2 executes the process steps of the platform for analyzing communication between a mobile device and a network, including managing the operation of the testing activity of mobile devices 106, 108, 110. Specifically, controller 116-2 communicates with mobile devices 106, 108, 110 (via agents described below). Controller 116-2 receives data (from such agents) including mobile device identifications (IDs) and agent status notifications and stores them in mobile device ID database 116-3 and agent and test status database 116-4, respectively. The stored mobile device IDs and agent statuses are associated with the respective mobile devices. The mobile device ID database 116-3 may also store other information including subscriber IDs, (operator assigned), agent license ID (licensing ID of hosting master agent), connected network name (WIFI SSID or operator name), connected network node ID (WIFI BSSID or LAC and Cell ID), connected network type (mobile or WIFI), last location, device mode and other information known to those skilled in the art. Agent and test status database 116-4 stores tests codes for tests, test names, test creation date, test types (WIFI, mobile or both), roaming, instructions for sending results of testing (e.g., via WIFI or mobile network), test coverage, device quantity for testing, device quantity responded, test completion ratios and any other information known to those skilled in the art. (Although one database is shown, those skilled in the art know that database 116-4 maybe be configured as two or more databases as desired.) This is described in more detail below with respect to the processes shown in FIGS. 4-5.

FIG. 3 depicts mobile device 106 as shown in FIG. 1. One or more software agents 106-1 are installed on mobile device 106 (for example) via a software development kit (SDK) within the operating system of mobile device 106. An agent is an executable file that comprises one or more tests to be run on the mobile device. That is, the agent receives an order from CMS 116 to execute tests (stored) on a mobile device and then executes the tests. The tests are described in more detail below. The operator (user) may schedule one or more tests via GUI 116-1 (on demand or by scheduled, once or periodically). Typically one agent is identified as a master agent and it is associated with a mobile device identification (ID), but there can be many agents associated with many third party applications downloaded and installed on a mobile device. For example, Facebook may wish to contract for an agent within its application to enable it to analyze data between the mobile device and the network. This is described in more detail below.

Reference is made to FIGS. 4 and 5 wherein flowcharts are depicted of example processes that form the steps of platform for analyzing the communication between a mobile device and CMS 116. GUI 116-1, controller 116-2, mobile device ID database 116-3, agent and test status database 116-4 and the application incorporating agents 106-1 are part of those processes as described below.

FIG. 4 depicts a flowchart of a process for registering a mobile device with CMS 116 in FIG. 1. In particular, this process is performed for each mobile device by means of a downloaded hosting mobile application (e.g., website or app store) as known to those skilled in the art. The hosting mobile application is employed to complete registration so that subsequent communication between a mobile device and CMS 116 is possible. In short, registration requires the assignment and transmission of a mobile device ID to mobile device ID database 116-1 in CMS 116 as follows.

Execution of the process begins at step 400 wherein a user will download and install an application on a mobile device 106, 108, 110. The application incorporates an agent in which one or more tests (i.e., synthetic transactions) are stored for subsequent execution. The tests are used to test, track and analyze various aspects of the communication between the mobile device and the wireless networks. Details of the tests are described in more detail below.

Execution then moves to step 402 wherein the hosting application checks for other agents that are associated with one or more applications on the mobile device 106, 108, 110. If a master agent exists at decision step 404, execution moves to steps 406 and 408 wherein (1) a new agent of the hosting application is designated as a slave agent and (2) the master agent and associated mobile device ID are maintained. Now, if a master agent does not exist (after checking), then execution moves step 410 wherein the new agent of the hosting application is designated as the master agent. Then, the designated master agent then generates (assigns) a new mobile device ID for the mobile device at step 412. (Other IDs may be assigned as well as required.) Following, the master agent transmits the mobile device to the CMS 116 at step 414 and stored in mobile device ID database 116-3 as shown in dotted line at step 416. Registration is then achieved. The mobile device ID is also stored in the mobile device ID database and it is associated with the new master agent at step 418.

Now, if an agent is deleted at decision step 420 (by deleting the application with master agent), then execution moves to step 422 wherein the slave agent is designated as master agent and it generates a mobile device ID at step 412 that will be associated with that master agent. The process then follows with step 414 as described above. The same steps occur following step 408. Those skilled in the art know that the process steps in FIG. 4 may have a different order, additional steps or may be removed to achieve the desired results.

FIG. 5 depicts a flowchart of a process for establishing communication between a mobile device 106 (for example) and CMS 116 to facilitate execution of tests for the analysis of the communication between mobile device 106 and a wireless network (e.g., carrier or WIFI network). For purposes of this discussion, this flowchart tracks the process steps of both the mobile device and CMS 116 together.

This process begins at execution step 500 wherein the master agent on mobile device 106 (for example) sends periodic status messages to CMS 116. The period is a variable set with a parameter by an operator (e.g., 10 minutes). These status messages indicate that mobile device 106 is alive and ready for communication with CMS 116 (i.e., “I am alive”). Execution then proceeds to steps 502 and 504 wherein controller 116-2 (in CMS 116) receives this message from mobile device 106 and analyzes the message to identify mobile device 106 by its mobile device ID. Then, the agent (mobile device) status is stored in the agent and test status database 116-4 by the mobile device ID at step 506.

Execution moves to step 508 wherein CMS 116 checks for test codes that are associated with the mobile device ID (where the master agent of a hosting application is installed). These test codes (when received by the mobile device) are instructions or execution orders for specific tests that are stored in the agent (for subsequent execution). As part of step 508, the ID received is compared with the IDs stored in mobile device database 116-3 at sub-step 508-1. If there is no ID match at sub-step 508-2, then controller 116-2 does not send any return message (step 510). If there is an ID match, execution moves to decision sub-step 508-3 wherein it is determined if there are any tests codes associated with the particular mobile device. If there are no test codes for mobile device 106, controller 116-2 will send a message to mobile device 106 merely confirming the connection with CMS 116 at step 512. The message will indicate that no test codes are available. If test codes exist for mobile device 106 (step 508-3), then execution moves to step 514 wherein controller 116-2 sends a message to mobile device 106 confirming connection along with one or more codes for the master agent to execute the tests. (As described above, the master agent is the active agent of a hosting application. The agents of the other applications are inactive.) Every code is part of a class of tests. The test codes are binary codes or parameters (X, Y) to turn on/off tests within the master agent as known by those skilled in the art. (It should be noted that the functionality of the agent is activated only if user consent is provided.)

Now, following step 512, execution moves to steps 516 and 518 wherein the message confirming the connection to the agent on mobile device 106 is received and the message is analyzed to identify the codes that are associated with the tests stored in the master agent. If the message contains no codes at decision step 520, execution ends at step 522. If the message includes codes, the master agent on mobile device 106 will execute these tests at step 524.

Execution then moves to step 526 wherein the results of the tests are sent to controller 116-2.

Now, controller 116-2 receives the results from mobile device 106 and stores the test status in agent and test status database 116-4 at step 528. Then, the data results are analyzed the results at step 530. As indicated above, an operator (user) may schedule tests to occur once or periodically by setting a parameter (e.g., every hour). The operator may enter new tests via GUI 116-1 and these tests (i.e., synthetic transactions) are stored in agent status and test database 116-4. Completed test status of a mobile device is also stored in this database as described above.

As described above, FIGS. 1-5 depict an embodiment of platform for analyzing communication between a mobile device and a wireless network wherein the mobile devices are registered and agent status is recorded in order to transmit instructions for the execution of the tests stored in the master agent on a mobile device. However, in an alternative embodiment, a push notification maybe employed to transmit instructions to the mobile devices for testing. This is described in more detail below.

With push notification (“silent push notification” as described below), the process for registering a mobile device with the central management system is executed as shown in FIG. 4. All mobile devices will be registered with CMS 116 as in FIG. 4. However, the process for establishing communication between a mobile device and CMS differs from that shown in FIG. 5. The alternative process is less complex because agent (mobile device) status is not necessary for executing this process. Accordingly, CMS 116-2a will incorporate the same components as shown in FIG. 2 except for the agent and test status database.

In this alternative process, a third party operator (e.g., Google, Apple, etc.) that provides push notification services to its subscribers will be employed to push messages to the mobile devices. These messages will be silent messages whereby the user will not be notified of these messages unless instructed otherwise. CMS 116 actually sends this push notification messages to the third party operators as known to those skilled in the art. In operation, controller 116-2, under the control of the third party operator, will forward messages (to all registered mobile devices) to a third party operator, and the third party operator will periodically send the messages (to all registered mobile devices that are identified by their IP addresses (known to the third party). These messages will include one or more codes to instruct registered mobile devices to execute the tests associated with the codes. As indicated above, every code is part of a class of tests. The test codes are binary codes or parameters (X, Y) to turn on/off tests within the master agent as known by those skilled in the art. The operator can delay testing as required for network operation.

Because CMS 116-2a is unaware of whether any mobile device is alive in this embodiment, the message is sent to all mobile devices but not all of these mobile devices will receive the message. These messages will be sent periodically under a push schedule. It is quite possible many of these mobile devices may not be active on the network, etc. Therefore, fewer mobile devices will return data results generated by the mobile devices running such tests. With this alternate process, controller 116-2 is more efficient because it works less. CMS 116-2a does not receive any traffic about agent (mobile device) status and avoids analyzing traffic (messages) to identify mobile device IDs. Consequently, the controller 116-2 is less expensive to create and operate in this embodiment.

Reference is now made to the exemplary tests used as described in this disclosure. (Those skilled in the art know that other tests may be used.) The test code is a binary or integer number depending on implementation and such codes are calculated based on a test configuration (i.e., the combination of tests among the available tests). The codes are known by the controller 116-2 and a mobile device agent.

Datagram Test. The paragon test computes the bandwidth between a mobile device and an access point (e.g., router or modem) of a WIFI network as known to those skilled in the art. The paragon test is frequently run via a WIFI network. The test requires a connection to a WIFI network. Controller 116-2 selects the mobile devices connected to WIFI only or the first time a mobile device is connected to that WIFI network. For example, the test will take five samples (adjustable) and sends all samples as well as the average to the CMS. The samples are in Mbps.

Ping/Delay Test. The ping test sends a ping (signal) from a mobile device to a WIFI gateway or access point to measure bandwidth and latency as known to those skilled in the art (e.g., minimum or maximum payload). In practice, the ping is sent to three destinations (to a first IP node in the IP router, to a second IP route and a content provider as the last IP address). The out is three values in milliseconds but may be designed for more or less values.

Device Test. The device test tests the performance of the device itself to determine if the device is an issue instead of the network. The device test includes CPU utilization, battery level, memory utilization, space and disk I/O. The test duration is 10 seconds typically, but could be changed parametrically.

Running Process List Test. The running process list test will identify the processes running on the mobile device including (for example) name of process, memory utilization, CPU utilization, disk I/O as known to those skilled in the art. The test will advise if there are too many processes running on a mobile device to run efficiently.

Speed Test. The speed test determines broadband capability. A file will be downloaded from CMS to a mobile device and the file will be uploaded from the mobile device to the CMS as known to those skilled in the art. For example, the file will be 40-50 MB but this may be changed.

Content Test. The content test will select broadband per content provider. The test duration is preferably 5 seconds by default or up to a download file size limit if reached (20 MB, but changeable). The test is to download a file from a content provider to determine the speed of the service as known to those skilled in the art. The output is the speed in download and upload. The content provider will be sent by controller 116-2 to a mobile device agent (e.g., Facebook, Instagram etc.).

Coverage/Location Test. This test will determine mobile network or WIFI signal strength at specified locations. Mobile network operator tests outages in cell coverage (e.g., cell tower down). This test will run periodically to measure signal strength at a location. Then, this information will be sent back to the CMS. Specifically, the test will be run for 60 seconds (or as desired) to get single strength and SINR (in WIFI) or signal strength (RSSI) and RSRQ (in LTE) or signal strength and ECIO (in CDMA or UMTS, when available) every 2 seconds or as desired. All values (number as desired) will be sent as well as average and standard deviation. Each value will have location (latitude, longitude as part of this).

Connected Device Test. The connected device test is used to determine the number of mobile devices in an area of WIFI access point. That is, this test will check the currently connected mobile devices to the same WIFI router. Mobile connectivity may also be checked. In practice, each master agent on mobile devices pings packets to other mobile devices. The other receiving mobile devices send a return response, and all of those devices send data back to the CMS. The data will include the number of connected devices, the MAC address and models of the connected mobile devices.

It should be noted that the CMS 116 will notify the billing management system of the operator of any testing activity that consumes data so that the user is not charged for the tests performed.

FIG. 6 depicts a block diagram of an example mobile device 600 along with its components. Mobile device 600 is an example of mobile devices 106, 108 and 110 described above. Mobile device 600 preferably incorporates similar conventional components as a personal computer (described below) including a processor, memory, storage and interface devices as known to those skilled in the art. In particular, mobile device 600 incorporates processor 600-1 configured to execute instructions and control other components of mobile device 600 in accordance with such instructions. Mobile device 600 further includes memory 600-2 for storing instructions including volatile and non-volatile memory such as random access memory and read only memory (RAM and ROM).

Mobile device 600 may communicate by wire or wireless means. Wireless communication is achieved by way of radio unit 600-3. Radio unit 600-3 is configured to communicate using radio frequency transmission. Radio unit 600-3 incorporates cellular, WIFI and Bluetooth transceivers for communication as known by those skilled in the art. Mobile device 600 may include a global positioning system (GPS) or such services may be performed using an application for GPS. Mobile device 600 also includes display adapter 600-4 and it is configured to control a display 600-5 for displaying application process and various activity information, alerts, notifications and the like. Display adapter 600-4 communicates with a display 600-5 and camera 600-6. Mobile device 600 also includes storage 600-8 for storing data and programs as known to those skilled in the art and light sensor 600-9 used to determine a level of brightness for the display for viewing. Device 600 may optionally include input/output adapters 600-7 as known to those skilled in the art. Mobile device 600 also includes a charging unit 600-8 for powering device 600. An accelerometer may optionally be incorporated for detecting movement of mobile device 600. Mobile device 600 may include other sensors as known to those skilled in the art. Mobile device 600 also includes an operating system 600-11 such as iOS, Android or Microsoft Windows Mobile along with other applications including Java etc. as known to those skilled in the art.

Mobile device 600 is equipped with industry standard (e.g., HTML, HTTP etc.) browsers or any other application having wired (e.g., Ethernet) or wireless access (e.g., cellular, Bluetooth, IEEE 802.11b etc.) via networking (e.g., TCP/IP) to nearby and/or remote computers, peripherals, and appliances, etc. TCP/IP (transfer control protocol/Internet protocol) is the most common means of communication today between clients or between clients and systems (servers), each client having an internal TCP/IP/hardware protocol stack, where the “hardware” portion of the protocol stack could be Ethernet, Token Ring, Bluetooth, IEEE 802.11b, or whatever software protocol is needed to facilitate the transfer of IP packets over a local area network.

FIG. 7 depicts a block diagram of a general-purpose computer to support the embodiments of the computer-implemented systems and methods disclosed herein. In a particular configuration, the computer 700 may be a server as described above with respect to the CMS 116 or personal computer. (CMS 116 is configured to enable part or all of the process steps of the application (software) in the embodiments described herein. The computer 700 typically includes at least one processor 700-1 and system memory 700-2 (volatile RAM or non-volatile ROM). System memory 700-2 may include computer readable media that is accessible to the processor 700-1. The memory 700-2 may also include instructions from processor 700-1, an operating system 700-3 and one or more application platforms 700-4 such as Java and a part of a one or more software applications or modules 700-9 such as the platform described above (as well as a browser and other applications).

The computer will include one or more communication connections such as network interfaces 700-5 to enable the computer to communication with other computers over a network, storage 700-7 such as a hard drives for storing data 700-8 and other software described above, video cards 700-6 and other conventional components known to those skilled in the art. This computer 700 typically runs Unix or Microsoft as the operating system and include TCP/IP protocol stack (to communicate) for communication over the Internet as known to those skilled in the art. A display 750 is optionally used. Computer server 400 typically includes TCP/IP protocol stack (to communicate) for communication over the Internet as known to those skilled in the art. Program Data 700-8 is also stored within computer server 700. The content providers also include a web server along with other servers hosted by the content provider as known by those skilled in the art. The content providers also include a web server along with other servers hosted by the content provider as known by those skilled in the art.

It is to be understood that the disclosure teaches examples of the illustrative embodiments and that many variations of the invention can easily be devised by those skilled in the art after reading this entire disclosure and that the scope of the present invention is to be determined by the claims below.

What is claimed is:

1. A method for providing a platform for analyzing communication between a mobile device and a wireless network, the method comprising:
checking on a central management system for one or more codes associated with one or more tests to be executed by an agent on the mobile device; and
sending, by the central management system, a message to the mobile device over the wireless network, wherein the message includes the one or more codes associated with the one or more tests to be executed by the agent.

2. The method of claim 1 further comprising:
receiving data generating by the one or more tests executed on a mobile device.

3. The method of claim 1 further comprising:
receiving a message from the mobile device, wherein the message includes a mobile device ID.

4. The method of claim 3 wherein checking for tests includes:
comparing the mobile device ID with one or more mobile device IDs stored in the central management system.

5. The method of claim 4 further comprising:
if the mobile device ID matches a mobile device ID stored in the central management system, sending the message to the mobile device, wherein the message further includes a notification confirming a connection between the mobile device and the central management system along with the one or more codes.

6. The method of claim 1 further comprising receiving, by a central management system, a message from a mobile device, indicating status of the agent on the mobile device.

7. The method of claim 1 further comprising registering a mobile device with the central management system.

8. The method of claim 1 wherein the wireless network includes a mobile network or a WIFI network.

9. The method of claim 1 wherein the message is sent directly or through a third party operator to the mobile device.

10. A system of providing a platform for analyzing communication between a mobile device and a wireless network, the system comprising:
a data storage to store:
a first database, wherein one or more mobile device IDs are stored in the first database;
a second database, wherein one or more codes associated with one or more tests to be executed by an agent on a mobile device; and
one or more servers configured to execute steps of a method, the steps comprising:
receiving a message from the mobile device, wherein the message includes a mobile device ID associated with the mobile device;
sending a message to the mobile device over the wireless network if the mobile device ID matches a mobile device ID stored in mobile device ID database, wherein the message includes one or more codes associated with one or more tests to be executed by an agent on the mobile device.

11. The system of claim 10 wherein the one or more servers are configured to execute steps of the method, the method further comprising:
comparing the mobile device ID with one or more mobile device IDs stored in the first database.

12. The system of claim 10 wherein the one or more servers are configured to execute steps of the method, the method further comprising::
checking for the one or more test codes stored in the second database if the mobile device ID matches a mobile device ID stored in the first database; and
sending the message to the mobile device, wherein the message further includes a notification confirming a connection between the mobile device and the one or more servers.

13. The system of claim 10 wherein the wireless network includes a mobile network or a WIFI network.

14. A system of providing a platform for analyzing communication between a mobile device and a wireless network, the system including one or more servers comprising:
at least one memory for storing computer-executable instructions; and
at least one processor in communication with the at least one memory, wherein the processor is configured to execute the computer-executable instructions to:
register a mobile device to enable communication with the one or more servers; and
send a message to the mobile device over the wireless network, wherein the message includes one or more codes associated with tests to be executed by the mobile device.

15. The system of claim 14, wherein the processor is configured to execute the computer-executable instructions to receive data resulting from the one or more tests executed by the mobile device.

16. The system of claim 14, wherein the processor is configured to execute the computer-executable instructions to compare a mobile device ID of the mobile device with one or more mobile device IDs stored on the one or more servers.

17. The system of claim 16, wherein the processor is configured to execute the computer-executable instructions to send the message to the mobile device if the mobile device ID matches a mobile device ID on the one or more servers, the message including a notification along with the one or more codes confirming a connection between the mobile device and the one or more servers.

18. The system of claim 14, wherein the wireless network is a mobile network or WIFI network.

19. A computer readable medium storing at least one computer program for providing a platform for analyzing communication between a mobile device and a wireless network, the at least one computer program comprising instructions, which when executed by one or more servers, cause one or more servers to:
check for one or more codes associated with one or more tests to be executed by an agent on the mobile device; and
send a message to the mobile device over the wireless network, wherein the message includes the one or more codes associated with the one or more tests to be executed by the agent.

20. A method of providing a platform for analyzing communication between a mobile device and a wireless network, the method comprising:
executing, by an agent on the mobile device, a synthetic transaction for measuring capability of the wireless network.

21. The method of claim 20 further includes receiving a code, by the agent on the mobile device, for executing the synthetic transaction.

22. The method of claim 20 wherein the agent is active and associated with a hosting application on the mobile device.

23. The method of claim 20 wherein one or more inactive agents are associated one or more hosting applications on the mobile device.
